(19) United States
(12) Patent Application Publication
(10) Pub. No.: US 2023/0314173 A1
(43) Pub. Date: Oct. 5, 2023

(54) ELECTRONIC DEVICE

(71) Applicant: VEGA Grieshaber KG, Wolfach (DE)

(72) Inventors: Roland WELLE, Hausach (DE); Karl GRIESSBAUM, Muehlenbach (DE)

(73) Assignee: VEGA Grieshaber KG, Wolfach (DE)

(21) Appl. No.: 18/040,709

(22) PCT Filed: Aug. 10, 2020
(86) PCT No.: PCT/EP2020/072425

§ 371 Date: Feb. 6, 2023

(30) Foreign Application Priority Data
Aug. 6, 2020 (WO) PCT/EP2020/072113

(51) Int. Cl. G01D 1/00

(52) U.S. Cl. CPC G01D 1/00

(57) ABSTRACT

An evaluation device is provided for processing measurement data from a measurement device, the evaluation device including: at least a first two-wire interface, configured for communication between the evaluation device and the measuring device; at least one first communication circuitry, configured to provide communication with the measurement device in a first communication mode via the at least one first two-wire interface; at least one second communication circuitry, configured to provide communication with the measurement device in a second communication mode via the at least one first two-wire interface; and at least one first selection circuitry, configured to activate the first communication circuitry or the second communication circuitry in such a manner that the evaluation device communicates with the measuring device via the at least one first two-wire interface in the first communication mode or in the second communication mode.

### REFERENCE TO RELATED APPLICATIONS

This application claims priority from International Patent Application No. PCT/EP2020/072 113, filed Aug. 6, 2020, which is incorporated herein by reference in its entirety.

### FIELD OF INVENTION

The present invention relates to an evaluation device for processing measurement data of a measurement device, a method for selecting a communication mode of such an evaluation device, a system for processing measurement data, and a use of a first, second or third communication unit in such an evaluation device and/or use of a measurement device in such a system.

### BACKGROUND

Evaluation devices for processing measurement data are generally known in the state of the art and are used, for example, in the process or chemical industry for monitoring process parameters such as fill levels, limit levels, pressures, densities, etc. The measured data are acquired by measuring devices and transmitted to a connected evaluation device via a corresponding interface.

In this context, it has now become apparent that there is a need to provide an evaluation device for processing measurement data which is suitable for such measurement data transmission, in particular there is a need to enable an efficient, cost-effective and sustainable evaluation device for processing measurement data.

It is therefore an object of the present invention to provide an evaluation device for processing measurement data for such transmission, and in particular there is a need to provide an efficient, cost-effective and sustainable evaluation device for processing measurement data.

These and other objects which will still be mentioned when reading the following description or which can be recognized by the person skilled in the art are solved by the subject matter of the independent claims. The dependent claims further form the central idea of the present invention in a particularly advantageous manner.

### SUMMARY OF THE INVENTION

An evaluation device according to the invention for processing measurement data of a measuring device, comprising: at least one first two-wire interface configured for communication of the evaluation device with the measuring device;

at least one first communication unit configured to provide communication with the measuring device in a first communication mode via the at least one first two-wire interface; at least one second communication unit configured to provide communication with the measuring device in a second communication mode via the at least one first two-wire interface; at least one first selection unit configured to activate the first communication unit or the second communication unit such that the evaluation device communicates with the measuring device in the first communication mode or in the second communication mode via the at least one first two-wire interface.

The term “measured value” is to be understood broadly and includes all physical measured variables, such as density, weight, temperature, distances, fill levels. The term evaluation devices is also to be understood broadly in the present context and includes all control and data processing devices that are suitable for analyzing or processing data, e.g. PLC, industrial PC, PC, smartphone, tablets, microcontroller. The term measuring device is also to be understood broadly in the present context and includes all devices that are suitable for the acquisition of a physical measurand, such as temperature sensors, radar sensors, capacitive sensors, pressure sensors, etc. Two-wire interfaces are based on a two-wire line and are suitable for transmitting a measured value and/or further data between the measuring device and an evaluation device. The two-wire interface can also serve to supply power to the measuring device. The term communication is to be understood broadly in the present context and considers any data exchange between the measuring device and the evaluation device, such as measurement data, status data of the measuring device and control commands. The term selection unit is to be understood broadly in the present context and includes hardware and software components that may be integrated in one assembly or distributed among multiple assemblies. For example, the selection unit may include a PLC or an integrated circuit (IC) or microcomputer chip. In the present context, the term communication unit includes a device that provides hardware and software for a communication mode. In this context, the hardware may be implemented via relay circuits, for example. The term communication mode in the following refers to communication technologies or communication modes such as current interface 4 . . . 20 mA, Highway Addressable Remote Transducer (HART) and Ethernet Advanced Physical Layer (Ethernet APL).

For data exchange, measuring devices and evaluation devices must provide/enable the same communication technology/standards. In existing plants in process technology, however, measuring devices with different communication modes are frequently in use, since the plants are often successively modernized or equipped with new evaluation devices and/or measuring instruments. If, for example, measuring devices with different communication modes are used, corresponding evaluation devices with different communication modes must also be used in order to be able to provide communication of these devices. However, this necessity increases the cost and also decreases the flexible use of the various devices in a plant. The present invention avoids or at least reduces these disadvantages.

In a particularly preferred embodiment, the evaluation device comprises a two-wire interface and adapts the communication mode depending on the communication mode present in the measuring device. This means that an existing two-wire line present in the system for connecting the evaluation device to the measuring device can be used. This leads to cost advantages if, for example, a new evaluation device according to the invention is to be implemented in an existing plant, since it is suitable for both old (e.g. 4 . . . 20 mA) and new communication modes (Ethernet APL), thereby also significantly reducing the implementation effort. In other words, an evaluation device according to the invention can be universally used for two or more communication modes.

In an embodiment, the evaluation device comprises a first communication unit and a second communication unit, wherein these use different modulation methods for implementing a data transmission. In particular, it may be intended to provide a first communication unit with a digital modulation method with a second communication unit with an analog modulation method.

For example, it can be provided that the first communication unit implements a digital communication according to the Ethernet Advanced Physical Layer (Ethernet APL) standard, and the second communication unit implements an analog communication according to 4 . . . 20 mA. In an embodiment, it can be provided that the second communication unit is designed to realize a mixed analog and digital communication according to the analog 4 . . . 20 mA standard with simultaneously digitally modulated signal according to the Highway Addressable Remote Transducer standard, hereinafter referred to as “4 . . . 20 mA/HART combined”.

In an embodiment, the evaluation device comprises a first communication unit and a second communication unit, wherein these use different digital or digital-only modulation methods to implement data transmission.

For example, the first communication unit may implement digital communication according to the Ethernet Advanced Physical Layer (Ethernet APL) standard, and the second communication unit may implement purely digital communication according to the Highway Addressable Remote Transducer (HART) standard.

Preferably, the evaluation device comprises a third communication unit, which is configured to provide communication with the measuring device in a third communication mode (HART or 4 . . . 20 mA or 4 . . . 20 mA/HART combined) via the at least one first two-wire interface, wherein the selection unit is configured to activate one of the communication units such that the evaluation device communicates with the measuring device in one of the communication modes via the at least one first two-wire interface. The provision of a third communication mode further increases the flexibility of the evaluation device.

Preferably, the evaluation device further comprises a second two-wire interface for communication between the evaluation device and a further measuring device; a fourth communication unit arranged to provide communication via the second two-wire interface with the further measuring device in the first communication mode (APL); a fifth communication unit arranged to provide communication via the second two-wire interface with the further measuring device in the second communication mode (HART or 4 . . . 20 mA or 4 . . . 20 mA/HART combined); a second selection unit which is configured to activate the fourth communication unit or the fifth communication unit in such a way that the evaluation device communicates via the second two-wire interface with the further measuring device in the first communication mode or in the second communication mode, the evaluation device preferably comprising a sixth communication unit which is configured to provide communication via the second two-wire interface with the measuring device in the third communication mode (HART or 4 . . . 20 mA or 4 . . . 20 mA/HART combined) . . . 20 mA/HART combined), the selection unit being configured to activate one of the communication units in such a way that the evaluation device communicates with the further measuring device via the second two-wire interface in one of the communication modes. The second two-wire interface and the additional communication modes allow a second measuring device to be connected to the evaluation device and operated with up to three different communication modes. This further increases the flexibility of the evaluation device.

Preferably, the evaluation device further comprises a third two-wire interface for communication between the evaluation device and a further measuring device; a seventh communication unit arranged to provide communication via the third two-wire interface with the further measuring device in the first communication mode (APL); an eighth communication unit arranged to provide communication via the third two-wire interface with the further measuring device in the second communication mode (HART or 4 . . . 20 mA or 4 . . . 20 mA/HART combined); a third selection unit arranged to activate the seventh communication unit or the eighth communication unit in such a way that the evaluation device communicates via the third two-wire interface with the further measuring device in the first communication mode or in the second communication mode, the evaluation device preferably comprising a ninth communication unit arranged to provide via the third two-wire interface communication with the measuring device in the third communication mode (HART or 4 . . . 20 mA or 4 . . . 20 mA/HART combined) . . . 20 mA/HART combined), the selection unit being configured to activate one of the communication units in such a way that the evaluation device communicates with the further measuring device via the third two-wire interface in one of the communication modes. The third two-wire interface and the additional communication modes allow a third measuring device with up to three different communication modes to be connected to the evaluation device and operated. This further increases the flexibility of the evaluation device.

Preferably, the first communication mode is an Ethernet Advanced Physical Layer (Ethernet APL) communication and the second and/or the third communication mode is/are a Highway Addressable Remote Transducer (HART) communication and/or a 4 . . . 20 mA current interface communication. The 4 . . . 20 mA communication mode is an analog communication mode, whereas the HART communication mode is already a digital communication mode. Both communication modes are widely used in existing plants, but are obsolete. Ethernet APL communication mode is one of the newer communication modes in the process industry. By providing these three communication modes, the evaluation device can be installed in both old plants and new ones. However, the communication modes provided by the evaluation device are not limited to the above examples, any other communication modes compatible with a two-wire technology can be selected. These still include, for example, 10BASET-1L, 10BASET-1S, Profibus PA, Foundation Fieldbus, Profinet, HART-IP, Modbus, Modbus-TCP or UPC-UA.

Preferably, the first and/or second and/or third selection unit is/are set up in such a way that the 4 . . . 20 mA current interface communication and HART communication are simultaneously connected to the first and/or second two-wire interface and the HART communication is modulated onto the 4 . . . 20 mA communication (4 . . . 20 mA/HART combined). Thus it is possible that the 4 . . . 20 mA communication unit and the HART communication unit are connected at the same time and the HART communication is only modulated onto the 4 . . . 20 mA.

Preferably, the communication units each comprise at least one circuit unit (hardware), each of which is configured to provide the operating parameters provided for the respective communication mode at the two-wire interfaces (current, voltage, modulation form), with the communication units preferably each comprising at least one software unit, each of which is configured to provide a communication protocol provided for the respective communication mode. The communication units thereby physically set and/or read out the operating parameters at the two-wire interface via circuits. The communication protocols can be e.g. 4 . . . 20 mA, HART, APL.

Preferably, the selection unit activates a communication unit based on a response signal from a measuring device to a communication signal from the selection unit. By activating the respective communication unit, the respective communication mode is provided. In other words, the communication mode of the measuring device is requested, and then the respective communication unit is turned on or off accordingly. In this context, the selection unit sends as a communication signal at least a first communication signal in the first communication mode to the measuring device and/or a second communication signal in the second communication mode to the measuring device and/or a third communication signal in the third communication mode to the measuring device and activates or deactivates the first, second and/or third communication mode based on a response signal from the measuring device. The determination or setting of the required communication mode can thereby advantageously be automated. By automating the communication mode determination or setting, the implementation effort can be reduced and the system availability can be increased.

Preferably, the evaluation unit comprises a fourth two-wire interface for communication of the evaluation device with a further evaluation device, preferably with a higher-level evaluation device; a tenth communication unit configured to provide communication with the further evaluation device via the fourth two-wire interface in the first communication mode (Ethernet APL); an eleventh communication unit configured to provide communication with the further evaluation device via the fourth two-wire interface in the second communication mode (HART or 4 . . . 20 mA or 4 . . . 20 mA/HART combined); a fourth selection unit which is configured to activate the tenth communication unit or the eleventh communication unit in such a way that the evaluation device communicates via the fourth two-wire interface with the further evaluation device in the first communication mode or in the second communication mode, the evaluation device preferably comprising a twelfth communication unit which is configured to provide communication via the fourth two-wire interface with the further evaluation device in the third communication mode (HART or 4 . . . 20 mA or 4 . . . 20 mA/HART combined) . . . 20 mA/HART combined), wherein the selection unit is configured to activate one of the communication units in such a way that the evaluation device communicates with the further evaluation device via the fourth two-wire interface in one of the communication modes; and wherein the evaluation device is preferably supplied with power via the further evaluation device via the fourth two-wire interface.

Preferably, the evaluation device comprises at least one power supply unit which is arranged to convert an incoming voltage and to supply the evaluation device and/or an energy storage device with energy and/or wherein the at least one power supply unit is operable in different operating modes and wherein the respective operating mode of the at least one power supply unit is selected based on the activated communication mode. In interaction with a microcontroller of the evaluation device, the power supply unit can further be designed to determine the maximum electrical power that can be drawn via the fourth two-wire interface, and to balance it in comparison with the power values drawn at the other two-wire interfaces in each case. If the evaluation device determines, for example, that an energy deficit is imminent, the power supply unit can be instructed by the microcontroller to reduce the supply voltages on the lines to the minimum permissible value for the communication standard used on the two-wire interfaces in order to save energy.

Preferably, the evaluation device is configured to determine whether a measuring device connected to a two-wire interface allows different communication modes and is further configured to determine a communication mode of such a measuring device. In this way, the evaluation device can, for example, select a communication mode in the presence of an energy deficit that leads to an energy saving and thereby ensure operational safety or operational capability.

Further, the invention relates to a method for selecting a communication mode of an evaluation device, comprising the steps of: Sending a first communication signal via a two-wire interface through a selection unit to a measuring device, the first communication signal being based on a first communication mode; activating a first communication unit when a response signal of the measuring device corresponds to the first communication mode; and/or sending a second communication signal via the two-wire interface through the selection unit to the measuring device, the second communication signal being based on a second communication mode; activating the second communication unit when a response signal of the measuring device corresponds to the second communication mode; and/or sending a third communication signal via a two-wire interface by the selection unit to a measuring device, the third communication signal being based on a third communication mode; activating the third communication unit when a response signal of the measuring device corresponds to the third communication mode. The method preferably runs in an automated manner, which reduces the implementation effort and reduces the error probabilities due to human intervention.

Furthermore, the invention relates to a system for evaluating/processing measurement data of a measurement device, comprising: at least one evaluation device; at least one measurement device, which is configured to communicate with the at least one evaluation device in a first communication mode and/or in a second communication mode and/or in a third communication mode.

Further, the invention relates to a use of a first, second, or third communication unit in an evaluation device; and/or a use of a measurement device in a system.

### DESCRIPTION OF THE PREFERRED EMBODIMENTS

Below is a detailed description of the figures, therein shows

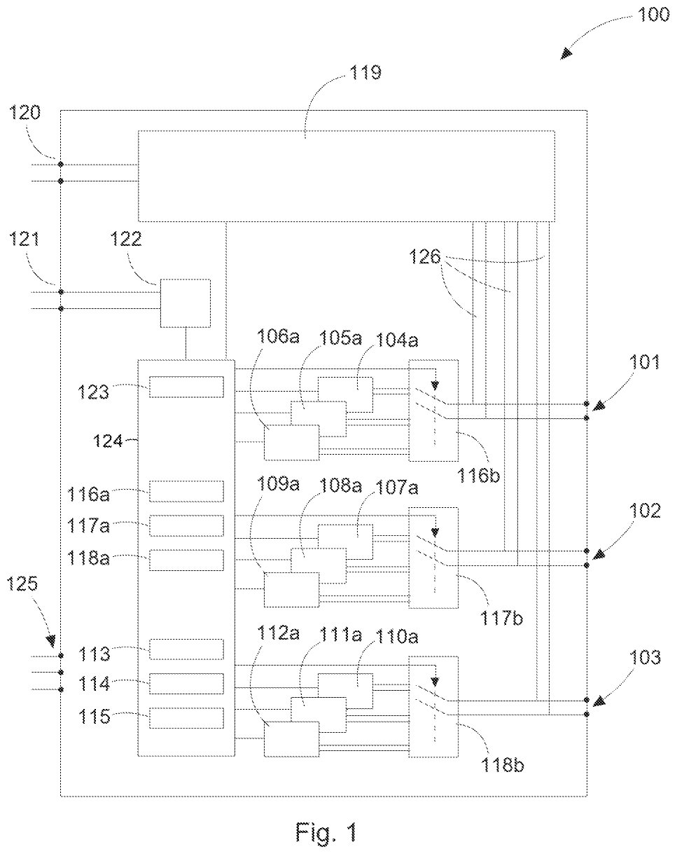

FIG. 1 a schematic view of a first preferred embodiment of an evaluation device according to the invention for processing measurement data of a measuring device;

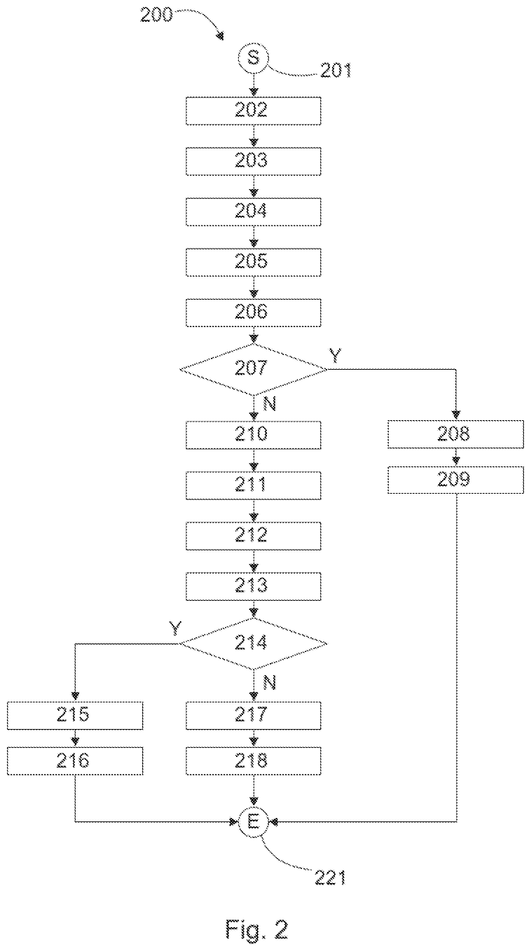

FIG. 2 a schematic representation of a method according to the invention for selecting a communication mode of the first preferred embodiment of an evaluation device according to the invention

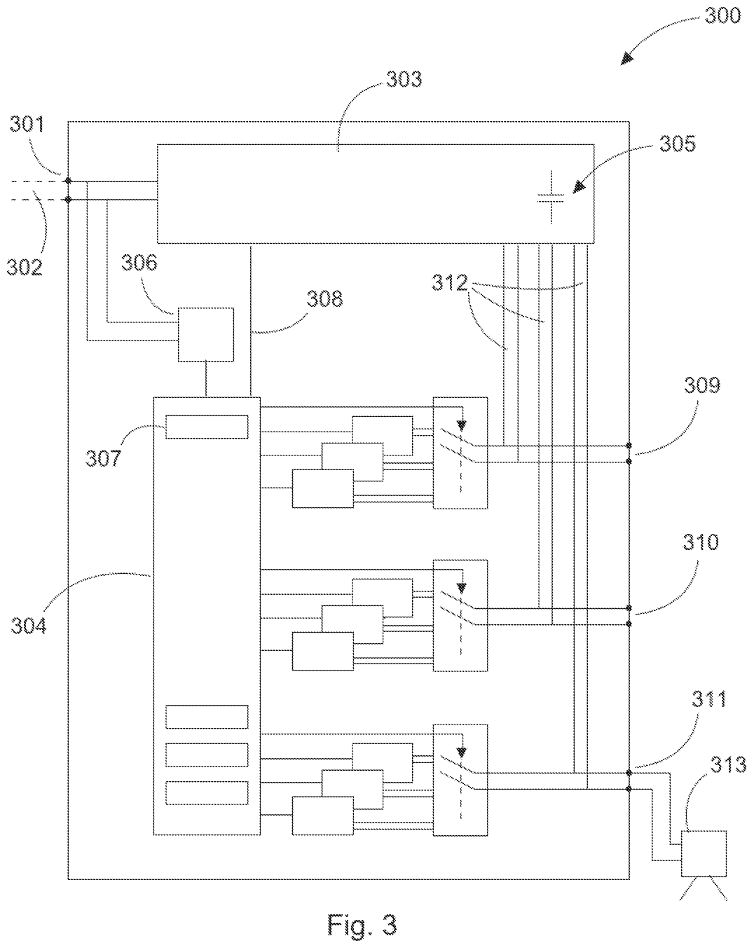

FIG. 3 a schematic view of a second preferred embodiment of an evaluation device according to the invention for processing measurement data of a measuring device; and

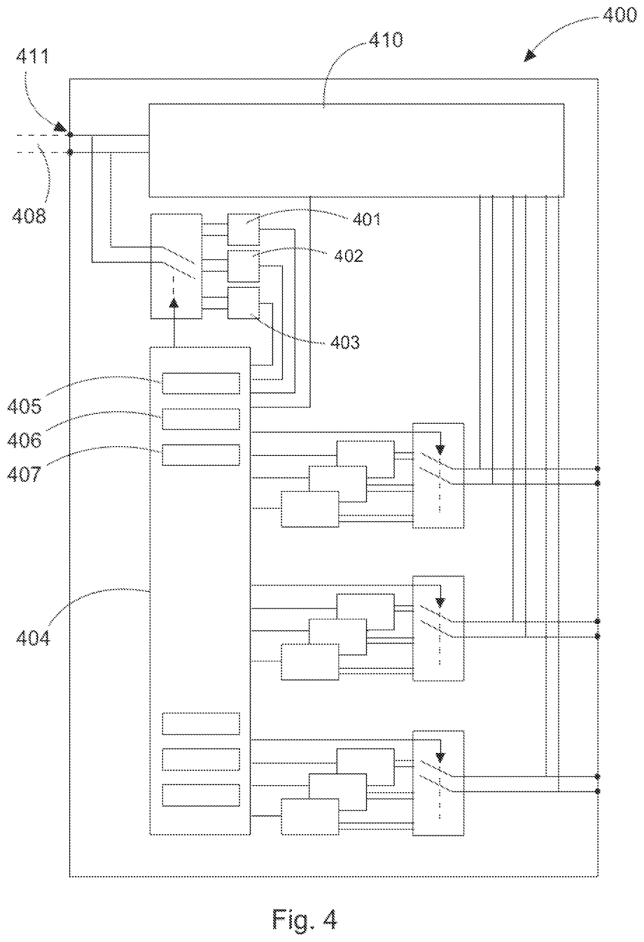

FIG. 4 a schematic view of a third preferred embodiment of an evaluation device according to the invention for processing measurement data of a measuring device;

FIG. 1 shows a schematic view of a first preferred embodiment of an evaluation device 100 according to the invention for processing measurement data of a measuring device.

The evaluation device comprises nine communication units 104, 105, 106, 107, 108, 109, 110, 111, 112 comprising circuit units 104a, 105a, 106a, 107a, 108a, 109a, 110a, 111a, 112a. The circuit units 104a, 105a, 106a, 107a, 108a, 109a, 110a, 111a, 112a are suitable for setting or reading out suitable voltages, currents and/or modulation forms at their respective two-wire interfaces 101, 102, 103 to different communication modes. The circuit units 104a, 105a, 106a, 107a, 108a, 109a, 110a, 111a, 112a are thus suitable to physically implement the communication via the two-wire lines connectable to the two-wire interfaces of the evaluation device 100. Furthermore, the communication units 104, 105, 106, 107, 108, 109, 110, 111, 112 comprise the software units 113, 114, 115, which are suitable to implement the protocol level of the respective communication mode. The evaluation device 100 obtains its energy necessary for operation from an energy supply interface 120, for example via a 230V mains supply. The energy is converted to different voltage levels by a power supply unit 119 integrated in the evaluation device 100, and made available to the other hardware units of the evaluation device 100. The evaluation device 100 further comprises a microcontroller 124 comprising software selection units 116a, 117a, 118a to drive hardware selection units 116b, 117b, 118b connected to circuit units 104a, 105a, 106a, 107a, 108a, 109a, 110a, 111a, 112a. The hardware selection units 116b, 117b, 118b are connected to the software selection units 116a, 117a, 118a.

In response to a signal from the software selection units 116a, 117a, 118a, the hardware selection units 116b, 117b, 118b are arranged to physically connect the circuit units 104a, 105a, 106a, 107a, 108a, 109a, 110a, 111a, 112a to the respective two-wire interfaces 101, 102, 103 and thus to a two-wire line.

Furthermore, it may be provided that the microcontroller 124 is connected to the power supply unit 119. Thus, it can be achieved that the power supply unit is instructed to make available a supply voltage suitable for the respective communication standard via the supply lines 126 at the two-wire interfaces 101, 102, 103. Consequently, the supply lines 121 are used to supply electrical power to the sensors which can be connected to the evaluation device 100. Furthermore, the control line between the microcontroller 124 and the power supply unit 119 can also be used to communicate to the microcontroller the current picked up by a device at a two-wire interface 101, 102, 103. In particular, in the case of purely analog communication via 4 . . . 20 mA communication mode, a measured value of a sensor can be acquired via this.

The microcontroller can process the measured values determined via the communication units 104, 105, 106, 107, 108, 109, 110, 111 and 112 and/or via the power supply unit 119, and use them in a known manner to control further devices such as pumps or valves, which can be connected to I/O interfaces 125. Alternatively or additionally, it can also be provided that the evaluation device 100 makes its data available to a further controller via a further bus interface 121, for example using Ethernet. For this purpose, the microcontroller 124 can be configured to combine a suitable electronic component 122 for controlling the respective communication mode and suitable communication software 123, and to implement the output of the signals. It may also be provided that a wireless interface is present instead of the bus interface 121.

It should be noted at this point that the hardware selection units 116, 117, 118 are shown schematically. The task of the hardware selection units 116, 117, 118 is to connect the appropriate circuit units 104a, 105a, 106a, 107a, 108a, 109a, 110a, 111a, 112a, which are necessary for implementing a particular communication mode, to the respective two-wire interfaces 101, 102, 103. This can be achieved, for example, via mechanical relays, solid state relays, or other switches. However, resistive-acting, capacitive-acting, or otherwise implemented electronic circuits can also effect coupling or decoupling of communication signals to the output signals. In addition, logic circuits can also be used at this point.

The software units 113, 114, 115 for protocol-side implementation of various communication standards may be present in a memory in the microcontroller 124. It may also be provided that they are stored in a memory outside the microcontroller 124, for example a non-volatile memory. It may be provided that these software units 113, 114, 115 are all loaded into the main memory of the microcontroller 124 during start-up. Alternatively, provision may be made to load the software units 113, 114, 115 only when necessary.

FIG. 2 shows a schematic representation of a method 200 according to the invention for selecting a communication mode of an evaluation device 100. The method starts in the start state 201, for example, whenever the power supply unit 119 registers a non-zero current flow at one of the respective two-wire interfaces 101, 102, 103. For this purpose, the power supply unit 119 applies a minimum supply voltage to each of the two-wire interfaces 101, 102, 103 already in the idle state. As an example, assume below that a sensor is connected to the two-wire interface 101. In step 202, the software selection unit 116a connects the two-wire interface 101 to the circuit unit 106a (Ethernet APL) by driving the hardware selection unit 116b. In step 203, circuit unit 106a (Ethernet APL) is activated. In step 204, software unit 115 (Ethernet APL) is loaded, and in step 205, power supply unit 119 is instructed to set the minimum required voltage at two-wire interface 101 for Ethernet APL communication mode. Then, in step 206, a communication signal is sent in Ethernet APL toward a sensor. In step 207, it is checked whether the sensor provides a response.

If this is the case, step 208 completes the initialization of Ethernet APL communication, and step 209 uses power supply unit 119 to set the maximum voltage for Ethernet APL.

If a sensor does not provide a valid Ethernet APL response, in step 210, the circuit unit 106a (Ethernet APL) is deactivated, and the circuit unit 105a (HART) is activated and connected to the two-wire interface 101 by appropriately driving the hardware selection unit 116b. In step 211, the power supply unit 119 is instructed to connect a voltage level suitable for the HART communication mode to the two-wire interface 101 before loading the software unit 114 (HART) in step 212. In step 213, a HART communication signal is transmitted to the sensor, and in step 214, a check is made to see if the sensor provides a valid response. If so, further HART initialization sequences are processed in step 215, and in step 216 the power supply unit 119 is instructed to raise the voltage at the two-wire interface 101 to the maximum voltage level intended for the HART communication mode.

If a sensor does not provide a valid HART response, in step 217 the circuit unit 105a (HART) is deactivated, and instead the circuit unit 104a (4 . . . 20 mA) is activated and connected to the output by driving the hardware selection unit 116b. In step 218, the power supply unit 219 is instructed to connect a voltage level suitable for the 4 . . . 20 mA communication mode to the interface 101. The procedure ends in state 221.

The aforementioned sequence can be automatically executed each time the evaluation device 100 is started up or ramped up after a voltage has been supplied to the power supply interface 120. In addition, when a current value greater than zero is detected on one of the two-wire interfaces 101, 102, 103, a corresponding sequence can be started. In this way, it can be achieved that a large number of sensors of different generations can be operated simultaneously, particularly in existing systems. If a modernization of the plant is carried out at a later time, for example by replacing a sensor with a newer sensor, an evaluation device according to the invention will automatically activate and use the new communication mode. In this way, it is possible to provide evaluation devices that enable the successive, staggered modernization of the sensors of existing plants.

In a further embodiment of the evaluation device 100, it may be provided that the evaluation device 100 performs an automated selection of a suitable communication standard based on an event on one of the two-wire interfaces 101, 102, 103 (voltage change, current change, etc.).

In a further embodiment, it may be provided that the evaluation device 100 adjusts to a predeterminable communication standard at one of the two-wire interfaces 101,102, 103 by user input.

FIG. 3 shows a schematic view of a second preferred embodiment of an evaluation device according to the invention for processing measurement data of a measuring device. The second preferred embodiment of the evaluation device 300 according to the invention differs from the first preferred embodiment described in FIG. 1 in that all of its power required for operation is drawn from a two-wire interface 301, which is also used for data exchange with a higher-level evaluation device, for example an APL power switch. The modified power supply unit 303 may be designed to convert the voltage levels of the two-wire line 302 into different voltage levels required by the microcontroller 304. In particular, energy storage devices 305 may be incorporated into the power supply unit 303 for this purpose. An electronic unit 306 matching the two-wire line 302, for example an APL-Phy (physical interface), can be configured to specify and/or evaluate voltages, currents and/or modulation forms thereof on the two-wire interface 301. A software unit 307 matching the communication mode on the two-wire line may be integrated in the microcontroller 304 and used to implement a communication on the two-wire line 302. The communication mode on the two-wire line 302 may be different from the communication standards used on the output side, or may match one of the standards provided on the output side.

The power supply unit 303, in interaction with the microcontroller 304 and a control line 308, may be further configured to determine the maximum electrical power obtainable via the two-wire interface 301, and to balance this power in comparison to the power values taken at the two-wire interfaces 309, 310, 311, respectively. For example, if the evaluation device 300 determines that a power deficit is imminent, the power supply unit 302 may be instructed, after control by the microcontroller 304, to reduce the supply voltages on the lines 312 down to the minimum value permitted for the respective communication mode used at the two-wire interface 309, 310, 311, thereby conserving power.

It is also possible to deactivate sensors connected on the output side in the event of an energy deficit and to send an error message to a higher-level controller.

In a particularly advantageous embodiment, an evaluation device 300 according to the invention can detect a measuring device 313 as part of the commissioning of a sensor at a two-wire interface 309, 310, 311, which in turn is configured to adapt its input interface to different communication standards. If a power deficit is detected by the evaluation device 300, it may briefly disconnect a measuring device 313 from the two-wire interface 311, and modify the communication mode of the respective two-wire interface 311 to a power-saving communication mode. After restarting the measuring device by activating the supply voltage on the two-wire interface 311, the measuring device 312 automatically adapts to the new communication mode, which may result in further energy savings. In a similar manner, a change to a communication standard that requires more power may also be provided in the event of an energy surplus.

FIG. 4 a schematic view of a third preferred embodiment of an evaluation device according to the invention for processing measurement data of a measuring device.

The evaluation device 400 comprises a plurality of electronic circuits or phy's or circuit units 401, 402, 403, for example an APL phy, a Profibus phy or an Ethernet phy. Suitably to these standards, the microcontroller 404 includes a plurality of software units 405, 406, 407 that can be loaded into memory as needed and executed to communicate according to a protocol used on the two-wire line 408. Control line 409 can be used to instruct power supply unit 410 to adapt to the particular communication mode used on the input side, for example by maintaining certain maximum input currents on two-wire interface 411.

Various communication modes can be used on the two-wire interface 411 and the two-wire line 408 for communication with a higher-level controller. By way of example, but by no means restrictively, Profibus PA, Foundation Fieldbus, Profinet, HART-IP, Modbus, Modbus-TCP or UPC-UA may also be mentioned here. Furthermore, the use of generally known Ethernet standards such as 10BASE-Tx, 100BASE-Tx, 1000-BASE-Tx or other standards with more than two wires is also possible. In particular, the communication modes can also be combined with Power over Ethernet.

The evaluation device 400 may further be configured to automatically determine the communication mode to be used for communicating with a higher-level controller after a voltage has been supplied to the two-wire interface 411.

In one embodiment of the evaluation device 400, the evaluation device 400 may be configured to perform an automated selection of an appropriate input-side communication standard at the two-wire interface 411 based on an event on the two-wire line 408 (voltage change, current change, etc.).

In a further embodiment of the evaluation device 400, the evaluation device 400 may be configured to be set to a presettable communication standard on the two-wire interface 411 by user input.

In a further embodiment of the evaluation device 400, it can be configured to determine its own measured values. A measurement value determination unit, which is not shown, can additionally be provided for this purpose.

However, the present invention is not limited in this regard to the foregoing preferred embodiments so long as it is encompassed by the subject matter of the following claims.

In addition, it is pointed out that the terms “comprising” and “having” do not exclude other elements or steps and the indefinite articles “a” or “an” do not exclude a plurality. Furthermore, the term unit is to be understood broadly, and in particular this term is not to be understood to mean that the respective units must be integral components. Also, the respective units may also be positioned differently. Finally, different units may also be combined in one assembly. Furthermore, it is pointed out that features or steps that have been described with reference to one of the above embodiments may also be used in combination with other features or steps of other embodiments described above.

### LIST OF REFERENCE SIGNS

100, 300, 400 Evaluation device
101, 102, 103, 301, 309, 310, 311, 411 Two-wire interface
104, 105, 106, 107, 108, 109, 110, 111, 112 Communication unit
113, 114, 115, 307, 405, 406, 407 Software unit
104a, 105a, 106a, 107a, 108a, Circuit unit
109a, 110a, 111a, 112a, 401, 402, 403 Circuit unit
116, 117, 118 Selection unit
116a, 117a, 118a Software selection unit
116b, 117b, 118b Hardware selection unit
119, 303, 410 Power supply unit
120 Energy supply interface
121 Bus interface
122 Electronic component
123 Communication software
124, 304, 404 Microcontroller
125 I/O interface
126 Supply line
302, 408 Two-wire line
305 Energy storage
306 Electronic unit
308, 409 Control line
312 Line
313 Measuring device

1.-15. (canceled)

16. An evaluation device for processing measurement data from a measurement device, the evaluation device comprising:
at least a first two-wire interface, configured for communication between the evaluation device and the measuring device;
at least one first communication circuitry, configured to provide communication with the measurement device in a first communication mode via the at least one first two-wire interface;
at least one second communication circuitry, configured to provide communication with the measurement device in a second communication mode via the at least one first two-wire interface; and
at least one first selection circuitry, configured to activate the first communication circuitry or the second communication circuitry in such a manner that the evaluation device communicates with the measuring device via the at least one first two-wire interface in the first communication mode or in the second communication mode.

17. The evaluation device according to claim 16,
further comprising a third communication circuitry configured to provide communication with the measuring device via the at least one first two-wire interface in a third communication mode,
wherein the at least one selection circuitry is further configured to activate one of the at least one first and the at least one second communication circuitry such that the evaluation device communicates with the measuring device via the at least one first two-wire interface in one of the first and the second communication modes.

18. The evaluation device according to claim 17, wherein the third communication mode includes a mixed analog and digital communication according to analog 4 mA to 20 mA with a simultaneously digitally modulated signal according to the Highway Addressable Remote Transducer (HART) standard.

19. The evaluation device according to claim 16, further comprising:
a second two-wire interface, configured for communication between the evaluation device and a further measuring device;
a fourth communication circuitry, configured to provide communication with the further measuring device in the first communication mode via the second two-wire interface;
a fifth communication circuitry, configured to provide communication with the further measuring device in the second communication mode via the second two-wire interface; and
a second selection circuitry, configured to activate the fourth communication circuitry or the fifth communication circuitry in such a way that the evaluation device communicates with the further measuring device via the second two-wire interface with the further measuring device in the first communication mode or in the second communication mode.

20. The evaluation device according to claim 19,
wherein the first communication mode includes the Ethernet Advanced Physical Layer (APL) standard, and
wherein the second communication mode includes a mixed analog and digital communication according to analog 4 mA to 20 mA with a simultaneously digitally modulated signal according to the Highway Addressable Remote Transducer (HART) standard.

21. The evaluation device according to claim 20,
further comprising a sixth communication circuitry, configured to communicate via the second two-wire interface with the measuring device in the third communication mode,
wherein the first and the second selection circuitry are configured to activate one of the first, the second, the third, the fourth, the fifth, and the sixth communication circuitry in such a way that the evaluation device communicates via the second two-wire interface with the further measuring device in one of the communication modes.

22. The evaluation device according to claim 16, further comprising:
a third two-wire interface, configured for communication between the evaluation device and a further measuring device;
a seventh communication circuitry, configured to provide communication with the further measuring device in the first communication mode via the third two-wire interface;
an eighth communication circuitry, configured to provide communication with the further measuring device via the third two-wire interface in the second communication mode;
a third selection circuitry, configured to activate the seventh communication circuitry or the eighth communication circuitry in such a way that the evaluation device communicates with the further measuring device via the third two-wire interface with the further measuring device in the first communication mode or in the second communication mode.

23. The evaluation device according to claim 22,
further comprising a ninth communication circuitry, configured to communicate via the third two-wire interface with the measuring device in the third communication mode,
wherein the first, the second, and the third selection circuitry are configured to activate one of the first, the second, the third, the fourth, the fifth, the sixth, the seventh, the eighth, and the ninth communication circuitry in such a way that the evaluation device communicates with the further measuring device via the third two-wire interface in one of the communication modes.

24. The evaluation device according to claim 16,
wherein the first communication mode includes the Ethernet Advanced Physical Layer (APL) standard, and
wherein the second and/or the third communication modes include a mixed analog and digital communication according to analog 4 mA to 20 mA with a simultaneously digitally modulated signal according to the Highway Addressable Remote Transducer (HART) standard, or the Ethernet APL standard.

25. The evaluation device according to claim 22,
wherein the first communication mode includes the Ethernet Advanced Physical Layer (APL) standard,
wherein the second and/or the third communication modes include a mixed analog and digital communication according to analog 4 mA to 20 mA with a simultaneously digitally modulated signal according to the Highway Addressable Remote Transducer (HART) standard, or the Ethernet APL standard, and
wherein the first and/or the second and/or the third selection circuitry are further configured in such a way that the Ethernet APL communication and the HART communication are simultaneously connected to the first and/or the second two-wire interface and the HART communication is modulated onto the Ethernet APL communication.

26. The evaluation device according to claim 16, wherein the first and the second communication circuitry are further configured to provide operating parameters and a communication protocol for a respective communication mode at the at least one first two-wire interface.

27. The evaluation device according to claim 16, wherein the at least one first selection circuitry is further configured to activate a communication circuitry based on a response signal of the measuring device to a communication signal of the at least one first selection circuitry.

28. The evaluation device according to claim 27, wherein the at least one first selection circuitry is further configured to send as a communication signal at least a first communication signal in the first communication mode to the measuring device, and/or to send a second communication signal in the second communication mode to the measuring device, and/or to send a third communication signal in a third communication mode to the measuring device, and to activate or deactivate the first, the second, and/or the third communication mode based on the response signal of the measuring device.

29. The evaluation device according to claim 16, further comprising:
a fourth two-wire interface, configured for communication between the evaluation device and a further evaluation device;
a tenth communication circuitry, configured to provide communication with the further evaluation device in the first communication mode via the fourth two-wire interface;
an eleventh communication circuitry, configured to provide communication via the fourth two-wire interface with the further evaluation device in the second communication mode; and
a fourth selection circuitry, configured to activate the tenth communication circuitry or the eleventh communication circuitry in such a way that the evaluation device communicates via the fourth two-wire interface with the further evaluation device in the first communication mode or in the second communication mode.

30. The evaluation device according to claim 29,
further comprising a twelfth communication circuitry, configured to communicate via the fourth two-wire interface with the further evaluation device in a third communication mode,
wherein the first, the second, the third, and the fourth selection circuitry are further configured to activate one of the first, the second, the third, the fourth, the fifth, the sixth, the seventh, the eighth, the ninth, the tenth, and the eleventh communication circuitry in such a way that the evaluation device communicates with the further evaluation device in one of the communication modes via the fourth two-wire interface, and
wherein the fourth two-wire interface is further configured to supply power to the evaluation device via the further evaluation device.

31. The evaluation device according to claim 16,
further comprising at least one power supply, configured to convert an incoming voltage and to supply the evaluation device and/or an energy storage device with energy,
wherein the at least one power supply is further configured to be operated in different operating modes, a respective operating mode of the at least one power supply being selected based on an activated communication mode.

32. The evaluation device according to claim 16, wherein the evaluation device is configured to determine whether the measuring device connected to the first two-wire interface allows different communication modes, and is further configured to determine a communication mode of the measuring device.

33. A method of selecting a communication mode of an evaluation device according to claim 16, the method comprising the steps of:
sending a first communication signal via a two-wire interface by a selection circuitry to a measurement device, wherein the first communication signal is based on a first communication mode;
activating a first communication circuitry when a response signal from the measuring device corresponds to the first communication mode; and/or
sending a second communication signal via the two-wire interface by the selection circuitry to the measurement device, wherein the second communication signal is based on a second communication mode;
activating the second communication circuitry when a response signal from the measuring device corresponds to the second communication mode; and/or
sending a third communication signal via a two-wire interface by the selection circuitry to a measurement device, wherein the third communication signal is based on a third communication mode;
activating the third communication circuitry when a response signal from the measuring device corresponds to the third communication mode.

34. A system for evaluating and/or processing measurement data of a measuring device, comprising:
at least one evaluation device according to claim 16; and
at least one measuring device configured to communicate with the at least one evaluation device in a first communication mode and/or in a second communication mode and/or in a third communication mode.
